(19) United States
(12) Patent Application Publication
(10) Pub. No.: US 2005/0216933 A1
(43) Pub. Date: Sep. 29, 2005

(54) Method and system which enables users to select videos from cable provider web site for on-demand delivery from the cable provider to user televisions via cable television network

(75) Inventor: Neville A. Black, Collegeville, PA (US)

Correspondence Address: BROOKS KUSHMAN P.C., 1000 TOWN CENTER, TWENTY-SECOND FLOOR, SOUTHFIELD, MI, 48075, US

(73) Assignee: Comcast Cable Holdings, LLC, Philadelphia, PA (US)

(21) Appl. No.: 10/946,419

(22) Filed: Sep. 21, 2004

Related U.S. Application Data
(63) Continuation-in-part of application No. 10/809,729, filed on Mar. 25, 2004.

(51) Int. Cl. H04N 7/173; G06F 13/00; H04N 5/445; G06F 3/00

(52) U.S. Cl. 725/34; 725/35; 725/46; 725/25

(57) ABSTRACT

A video-on-demand system and method includes a cable provider having videos available for delivery to an STB associated with a user television. The user accesses the provider's Internet web site which lists titles of the videos to provide user identification (ID) information to the provider and to select a video. The provider uses the user ID information and information indicative of the selected video to deliver the title of the selected video to the STB via a cable network. The STB displays titles of videos previously selected by the user from the web site on the television in response to the user directing the STB to display titles of previously selected videos on the television. The provider delivers a previously selected video to the STB via the cable network for the STB to show on the television in response to the user choosing the title of the previously selected video.

### CROSS-REFERENCE TO RELATED APPLICATIONS

This application is a continuation-in-part of U.S. application Ser. No. 10/809,729; entitled “Method and System which Enables Subscribers to Select Videos from Websites for On-Demand Delivery to Subscriber Televisions via Cable Television Network”; filed Mar. 25, 2004; and the disclosure of which is hereby incorporated by reference in its entirety.

### BACKGROUND OF THE INVENTION

1. Field of the Invention

The present invention generally relates to video-on-demand (VOD) methods and systems and, more particularly, to a method and system which enables users of a cable television service provider (“cable provider”) to select videos listed on an Internet web site of the cable provider using personal computers connected to the Internet for on-demand delivery of the selected videos from the cable provider to user televisions via a cable television network.

2. Background Art

A cable television service provider (“cable provider”) distributes videos “on-demand” to user televisions via a cable television network for users (i.e., viewers, subscribers, members of the subscriber household, etc.) to view in response to user requests for the videos. This video distribution service is generally referred to as “video-on-demand” (“VOD”). In operation, a user of the cable provider transmits a request for a video over the cable television network to the cable provider. The cable provider then delivers the requested video over the cable television network to the user's television for the user to view.

The user's television has a cable television network transceiver such as a set-top-box (STB) or the like which connects the user's television to the cable television network. The cable provider transfers information to the STB to cause the STB to display a graphical user interface (GUI) such as a television electronic program guide (EPG) or the like on the user's television. For example, the EPG may be a “folder” which lists the titles of videos available to the user by the cable provider. To request an available video from the cable provider, the user uses a television remote control or the like to select a folder entry corresponding to the title of the requested video. The STB then transmits a request corresponding to the requested video over the cable television network to the cable provider. In response, the cable provider delivers the requested video over the cable television network for receipt by the STB of the user's television. The STB then provides the video on the user's television for the user to view.

A problem with selecting videos from a list of video titles displayed on the user's television is that it is difficult to enable the user to perform browsing and searching functions of the video title information displayed in different folders using the user's television. It is much easier to enable users such as subscribers of the cable provider to browse and search video titles listed on Internet web sites using personal computers connected to the Internet.

### SUMMARY OF THE INVENTION

Accordingly, it is an object of the present invention to provide a method and system which enables users of a cable television service provider (“cable provider”) to select videos listed on an Internet web site of the cable provider using personal computers connected to the Internet for on-demand delivery of the selected videos from the cable provider to user televisions via a cable television network.

In carrying out the above object and other objects, the present invention provides a video-on-demand (“VOD”) system. The VOD system includes a cable television service provider (“cable provider”) which has videos which are available for delivery from the cable provider to a user of the cable provider. A “user” includes an entity such as an individual having a subscription with the cable provider either directly or indirectly. For example, a user is a subscriber, or is an individual that is present in the household of the subscriber. As such, a user includes individuals that use the services of the cable provider such as viewers, subscribers, members in the residence of the address corresponding to the billing address of a subscription, etc.

The VOD system further includes a set-top-box (STB) associated with the subscriber; a television associated with the STB; a cable television network connecting the STB and the cable provider; and a personal computer (“computer”) connected to the Internet.

The cable provider has an Internet web site listing titles and descriptive information of the videos. The user uses the computer to access the web site in order to provide user identification (ID) information to the cable provider and to select a video. The cable provider uses the user ID information and information indicative of the selected video to deliver the title of the selected video to the STB via the cable television network. The STB displays the titles of videos previously selected by the user from the web site on the television in response to the user directing the STB to display the titles of the previously selected videos on the television. The cable provider delivers a previously selected video to the STB via the cable television network for the STB to show on the television in response to the user choosing the title of the previously selected video.

The cable provider may have plurality of video servers which store the videos with the cable television network connecting a given one of the video servers to the STB. In this case, the cable provider identifies the given video server based on the user ID information. In turn, the given video server uses the user ID information and the information indicative of the selected video to deliver the title of the selected video to the STB via the cable television network; and the given video server delivers the previously selected video to the STB via the cable television network for the STB to show on the television in response to the user choosing the title of the previously selected video.

The cable provider may have a Server Locator Service (SLS) for identifying the given video server based on the user ID information.

The user ID information may be indicative of IDs of STBs which are associated with televisions of the user. In this case, the given video server uses the STB IDs and the information indicative of the selected video in order to deliver the title of the selected video to the STBs via the cable television network; and the given video server delivers the previously selected video to at least one of the STBs via the cable television network for the at least one of the STBs to show on the associated television in response to the user choosing the title of the previously selected video.

The cable provider may have an asset management system (AMS) which provides video listing data indicative of the available videos to the web site for the web site to use in order to list the titles of the available videos.

The web site may determine a service area of the user from the user ID information. In this case, the web site lists the titles of the available videos as a function of the service area of the user. The cable provider may deliver the previously selected video to a video recorder associated with the STB via the cable television network in response to the user choosing the title of the previously selected video. The user may perform a key word search on the web site using the computer in order to select the title of the selected video. The user may use the computer to browse categories listed in the web site in order to select the title of the selected video.

Also, in carrying out the above object and other objects, the present invention provides an associated VOD method and another VOD system.

### BRIEF DESCRIPTION OF THE DRAWINGS

FIG. 1 illustrates a block diagram of a video-on-demand (VOD) system in accordance with the present invention.

### DETAILED DESCRIPTION OF THE PREFERRED EMBODIMENT(S)

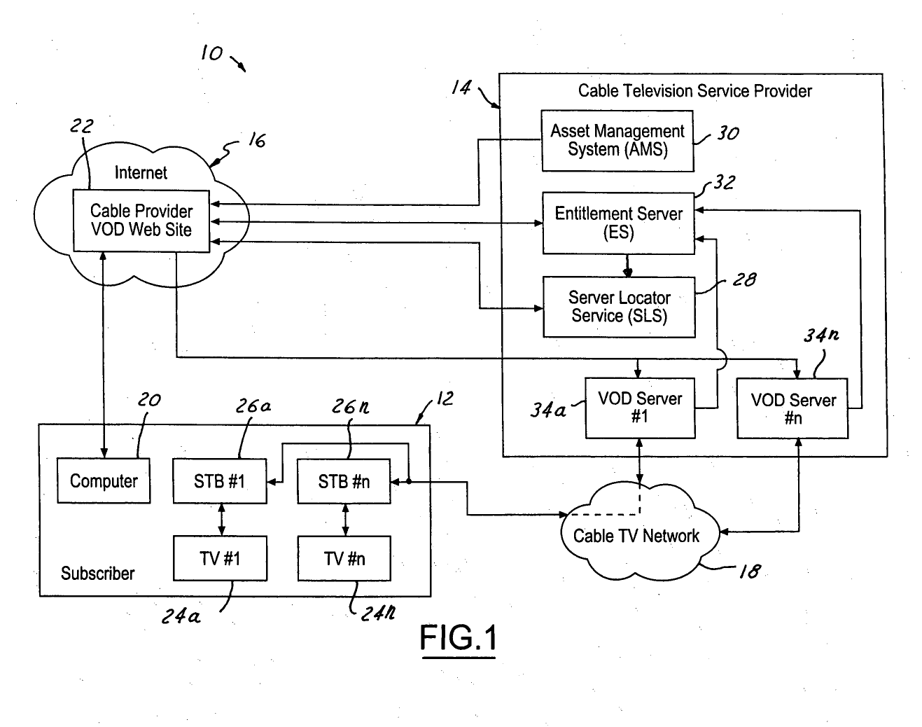

Referring now to FIG. 1, a block diagram of a video-on-demand (VOD) system 10 in accordance with the present invention is shown. VOD system 10 includes two communications networks for communicating with subscribers (e.g., viewers, users, household/residence members, etc.) such as a subscriber 12 of a cable television service provider (“cable provider”) 14. One communications network is Internet 16 and the other communications network is a cable television network 18. Internet 16 connects a personal computer (“computer”) 20 to a VOD web site 22. VOD web site 22 is associated with cable provider 14. Computer 20 is accessible to subscriber 12. Internet 16 also connects cable provider 14 to VOD web site 22. As such, Internet 16 connects cable provider 14 and computer 20 via VOD web site 22. Cable television network 18 connects a television 24 of subscriber 12 to cable provider 14.

In general, VOD system 10 enables subscriber 12 to select a video from VOD web site 22 using Internet 16 and computer 20. In turn, VOD system 10 enables cable provider 14 to deliver the selected video to television 24 via cable television network 18 for the subscriber to view on the television.

Computer 20 has a web browser which enables subscriber 12 to browse and search Internet web sites such as VOD web site 22 via Internet 16. Subscriber 12 may enter “key words” in computer 20 in order to browse and search VOD web site 22. Cable provider 14 lists the videos on VOD web site 22 which are available for delivery from the cable provider to subscribers via cable television network 18. The listing may include a list of video titles arranged in categories and a promotional description of each listed video. Subscriber 12 uses computer 20 to browse and search VOD web site 22 in order to select videos for on-demand delivery to the subscriber from cable provider 14.

Subscriber 12 generally has a plurality of televisions 24a, 24n which are typically located in a subscriber's premise. Each television 24 is associated with a respective communications network transceiver such as a set-top-box (STB) 26 or the like. As shown in FIG. 1, STB 26a is associated with televison 24a; and STB 26n is associated with television 24n. STBs 26a, 26n connect their respective televisions 24a, 24n to cable television network 18. Each STB 26a, 26n has an associated STB identification (ID). Cable television network 18 (typically a hybrid fiber coax (HFC) network) and STBs 26a, 26n together enable two-way communications between cable provider 14 and subscriber 12 in order to provide the subscriber with VOD services.

For typical VOD operation, subscriber 12 transmits a request for a video from an STB 26 over cable television network 18 to cable provider 14. In response to this request, cable provider 14 transmits the requested video over cable television network 18 to STB 26 for subscriber 12 to view on television 24.

Cable provider 14 includes a Server Locator Service (SLS) 28, an asset management system (AMS) 30, an Entitlement Server (ES) 32, and a plurality of video servers 34a, 34n. Video servers 34a, 34n store copies of the available videos. Video servers 34a, 34n connect to cable television network 18 via a head end (not shown) in order to deliver videos from cable provider 14 over the cable television network to STB 26 for the subscriber to view on television 24, and to enable the cable provider and the subscribers to communicate with one another.

AMS 30 generates basic listing data (i.e., metadata) for the videos which are available for delivery from cable provider 14 to subscribers. AMS 30 provides this basic listing data to VOD web site 22. VOD web site 22 uses the metadata to generate the title listing of available videos and descriptions of the available videos for subscriber 12 to view when accessing the VOD web site from computer 20.

Subscriber 12 uses computer 20 to connect to Internet 16 and access VOD web site 22. Subscriber 12 has a subscriber identification (ID) such as an account number or the like. The subscriber ID identifies the subscriber. Subscriber 12 provides the subscriber ID to VOD web site 22 when logging onto the VOD web site via use of a typical Internet web site login procedure. Subscriber 12 then browses the titles and the descriptions of the videos listed in VOD web site 22 in order to select videos for on-demand delivery from cable provider 14 to subscriber 12. Subscriber selects videos from VOD web site 22 by transmitting, from computer 20 to VOD web site 22, requests corresponding to the titles of the selected videos.

After subscriber 12 confirms the video selections, VOD web site 22 communicates with entitlement server 32 to determine whether the selected videos may be delivered by cable provider 14 to subscriber 12. To this end, VOD web site 22 provides the subscriber ID to entitlement server 32. In response, entitlement server 32 uses the subscriber ID to determine whether subscriber 12 is authorized to receive the selected videos from cable provider 14. That is, entitlement server 32 uses the subscriber ID to determine whether subscriber 12 is “entitled” or has a “subscription” with cable provider 14 to view certain types of video content. Entitlement server 32 then provides an indication to VOD web site 22 regarding the type of video content to which subscriber 12 is authorized to receive.

Entitlement server 32 also uses the subscriber ID to identify the STBs 26a, 26n associated with subscriber 12. With the indication regarding the type of video content to which subscriber 12 is authorized to view, entitlement server 32 also provides the STB ID of each STB 26 associated with subscriber 12 to VOD web site 22.

Upon receiving the video content access information and the STB IDs from entitlement server 32, VOD web site 22 checks the video content entitlement to ensure that subscriber 12 is entitled to view each selected video. VOD web site 22 provides an indication to computer 20 for subscriber 12 regarding any of the selected videos to which subscriber 12 is not entitled. In turn, cable provider 14 does not provide these non-entitled videos to subscriber 12.

In general, cable provider 14 delivers the selected videos to which subscriber 12 is entitled over cable television network 18 to an STB 26 for subscriber 12 to view on the television 24 associated with the STB. More specifically, one of the VOD servers 34a, 34n delivers the selected videos over cable television network 18 to STB 26 for subscriber 12 to view on television 24. VOD servers 34a, 34n are generally configured with cable television network 18 such that only a subset of the VOD servers 34a, 34n are connected by cable television network 18 to subscriber STB 26. For example, VOD server 34a is configured with cable television network 18 to deliver videos to STB 26 whereas VOD server 34n is not. Likewise, VOD server 34a is not configured with cable television network 18 to deliver videos to a second subscriber STB whereas VOD server 34n is operable for delivering videos to the second subscriber STB.

As such, delivering selected videos to subscriber 12 requires that cable provider 14 determine the appropriate VOD server for handling this task. To this end, VOD web site 22 uses the subscriber ID to query SLS 28 for the identity of VOD server 34 which communicates with STBs 26a, 26n of subscriber 12. In response to this query, SLS 28 provides to VOD web site the identity of the VOD server 34 which is configured to communicate with STBs 26a, 26n of subscriber 12. In this example, the appropriate VOD server for delivering selected videos to STBs 26a, 26n of subscriber 12 is VOD server 34a, i.e., the VOD server which serves subscriber 12 and which communicates display information to STBs 26a, 26n for televisions 24a, 24n via cable television network 18. The process employed by cable provider 14 for determining the identity of the appropriate VOD server is described in further detail underneath the heading “Locating VOD Servers” located below in this Detailed Description.

At this point, the summary of the operation is as follows. Initially, subscriber 12 accesses VOD web site 22 to select videos for on-demand delivery from cable provider 14. During this selection process, VOD web site 22 obtains the susbcriber ID. VOD web site 22 then provides the subscriber ID to entitlement server 32. Entitlement server 32 uses the subscriber ID to determine whether subscriber 12 has is entitled to view the selected videos. Entitlement server 32 then provides to VOD web site 22 an indication of the type of content to which subscriber 12 is entitled to view, and a list of the STB IDs associated with the subscriber. VOD web site 22 queries SLS 28 with the subscriber ID for the identity of the VOD server 34a which communicates with STB 26a, 26n. VOD web site 22 then has the following pieces of information: 1) video ID information identifying the selected videos to which subscriber 12 is entitled to view; 2) the subscriber ID; and 3) the STB IDs; and 4) the identity of VOD server 34a which communicates with STB 26a, 26n. The video ID information identifies the selected videos and may include identification such as content provider ID and asset ID.

As such, the operation now turns to actually delivering the selected videos from cable provider 14 to subscriber 12. To this end, VOD web site 22 provides to VOD server 34a the following pieces of information: 1) the selected video ID information; 2) the subscriber ID; and 3) the STB IDs. In turn, VOD server 34a processes this information into an internal database and associates the selected videos with subscriber 12 and STB 26a, 26n associated with the subscriber. When subscriber 12 opens a “Web Selections” folder displayed on subscriber television 24a, VOD server 34a transmits the titles of the selected videos and perhaps other descriptive information regarding the selected videos over cable television network 18 to STB 26a for the subscriber to view in the “Web Selections” folder which is displayed on television 24a.

Again, these “selected” videos were previously selected by subscriber 12 from VOD web site 22. VOD server 34a uses the same metadata provided from AMS 30 in order to populate the “Web Selections” folder with the information regarding the selected videos. Subscriber 12 then uses a television remote control or the like to select a folder entry corresponding to a requested one of the previously selected videos. STB 26a then transmits a video request corresponding to the requested video over cable television network 18 to cable provider 14. In response, VOD server 34a delivers the requested video over cable television network 18 for receipt by STB 26a. STB 26a then provides the requested video on television 24a for subscriber 12 to view.

In addition to the above mode of video delivery, cable provider 14 may deliver selected videos to subscriber 12 in other ways. For example, for subsequent viewing of selected videos, STB 26 may have storage such as a digital video recorder (DVR) or the like. In this case, VOD server 34a delivers the selected videos at opportune transmission times over cable television network 18 to STB 26. The DVR of STB 26 stores the selected videos as the selected videos are transmitted to the STB. Subscriber 12 then views the selected videos on television 24 at a later time. At the later time, STB 26 streams the selected videos stored on the DVR to television 24 for subscriber 12 to view.

In the case of the DVR of STB 26 storing the selected videos, the STB may also be configured to display the “Web Selections” folder on television 24. The “Web Selections” folder displayed on television 24 is a listing of the titles of the videos which subscriber 12 has selected from web site 22. In this case, subscriber 12 communicates a request to STB 26 by highlighting an appropriate entry in the folder. In turn, STB 26 streams the selected video stored on the DVR to television 24 for subscriber 12 to view.

An advantage of the present invention is that subscriber 12 is able to perform much better browsing and searching functions using computer 20 in order to select videos from VOD web site 22. As noted above, such browsing and searching functions of videos available for delivery from cable provider 14 to subscriber 12 are difficult to perform using television 24 and STB 26.

Computer 20 and television 24 may be located in the same general vicinity such as at the residence or household of subscriber 12. In this case, computer 20 is typically connected to Internet 16 using dial-up modem, cable modem, or digital subscriber line communications technologies. Computer 20 and television 24 may also be located remotely from one another. For example, computer 20 may be located in a school, library, office, etc., whereas television 24 is located in the residence or household of subscriber 12. As such, subscriber 12 need not even own computer 20 in order to select a video from VOD web site 22 for delivery from cable provider 14 to the subscriber via cable television network 18. In either case, computer 20 and television 24 are not in direct communication with one another. That is, no direct connection is required between computer 20 and television 24 in order for VOD system 10 to function in accordance with the present invention.

In accordance with the present invention, VOD web site 22 generally displays a title list of videos which are available for delivery from cable provider 14 to the subscribers of the cable provider. However, videos available to a first set of subscribers in one cable provider service area or region may not necessarily be available to a second set of subscribers in another service area. As such, VOD web site 22 only displays a title listing of the videos which are available to a particular subscriber accessing the VOD web site. That is, VOD web site 22 is different for different subscribers depending upon the service areas in which the subscribers are located. As such, for a particular subscriber, VOD web site 22 displays a partial listing of videos from a complete listing of videos which are available to all of the subscribers taken as a whole.

That is, VOD web site 22 displays a listing of videos available to a particular subscriber as a function of the service area in which the subscriber is located. To this end, VOD web site 22 uses the subscriber ID information provided by the subscriber when logging onto the VOD web site. The subscriber ID information includes information indicative of the service area in which the subscriber is located. For example, such information indicative of the service area in which the subscriber is located is the zip code of the subscriber's residence. VOD web site 22 uses this information to display a listing of the videos which are available for delivery to the zip code of the subscriber's residence. This can be done by either including or excluding a list of video titles in VOD web site 22 depending upon the zip code of the subscriber. As such, the subscriber views and selects videos from VOD web site 22 which are available for delivery to the subscriber based on the service area of the subscriber.

Locating VOD Servers

As indicated above, delivering selected videos from cable provider 14 to subscriber 12 requires that the cable provider determine the appropriate VOD server 34a, 34n for handling this task. Thus, cable provider 14 is operable to dynamically determine which VOD server 34a, 34n is operable for communicating with a particular subscriber or STB 26 via cable television network 18. Such a VOD server is an appropriate VOD server for a particular subscriber. Cable provider 14 determines the appropriate VOD server 34a, 34n in order to direct data and content to the appropriate VOD server.

Each VOD server 34a, 34n has a unique name. The unique name can be effected by adopting the convention that the VOD server name is formed by the combination of the name of the regional operations center with which the VOD server is associated and a local name that is unique within the scope of the regional operations center. For example, the VOD server name NewCastle.sc_vod03.

In operation, each VOD server 34a, 34n periodically (e.g., every few minutes) sends information about the most recent contact with a particular STB to SLS 28. SLS 28 captures the information in a data base table (which is part of a data base of entitlement server 32):

TABLE
STB Server

| Field | |
|---|---|
| Server Type | e.g. “VOD”, “GAME” . . . |
| Server Name | |
| STB MAC | 12 hex digits |
| Date and Time | |

The appropriate VOD server for a particular STB is determined by using the subscriber ID information, i.e., the subscriber account number, the information indicative of STB 26, etc. Given the subscriber account number for subscriber 12, the STB ID (i.e., the media access control (MAC) value for STB 26 of subscriber television 24) is obtained. The MAC value is then used to look up the name of the appropriate VOD server for subscriber STB 26 from the table STB Server. The most recent data and time value of the matching record is deemed authoritative.

The subscriber STB(s) are captured from updates to billing system data. It may happen that an STB is removed from a residence of one subscriber and subsequently assigned to the residence of another subscriber, and that the two residences are serviced by different VOD servers. Thus, in table STB Server, the same STB MAC value may be associated with more than one Server Name for the same Server Type. The most recent “Date and Time” value will distinguish the correct Server Name.

Occasionally a re-configuration results in changing the particular VOD server that services a particular residence or house. This may well result in “conflicting” entries in the table STB Server: the old and new VOD servers for the same STB MAC. Again, the most recent “Date and Time” value will distinguish the appropriate Server Name.

Entitlement server 32 can proxy the responsibility of notifying SLS 28 of the association of an STB to a VOD server as VOD servers 34a, 34n frequently make enquiries to the entitlement server. Entitlement server 32 can apply a suitable policy, e.g. “weekly”, as to how often to “refresh” SLS 28 when, as is most likely, a given STB is associated with a particular VOD server for a relatively long time. For every STB, entitlement server 32 should maintain a “Time of Next Location Report” (TNLR). This value should be set to “Now” when an STB recorded is added to the database of entitlement server 32.

For each VOD server 34a, 34n, entitlement server 32 records the most recent STB contact, updating the Time value each time it receives an enquiry from a VOD server 34a, 34n. Every few minutes, entitlement server 32 messages the SLS with the STB contact data for all STBs with TNLR in the past, and updates the TNLR according to the policy value.

Thus, it is apparent that there has been provided, in accordance with the present invention, a method and system which enables subscribers of a cable provider to select videos listed on a web site of the cable provider using computers connected to the Internet for on-demand delivery of the selected videos from the cable provider to subscriber televisions via a cable television network that fully satisfy the objects, aims, and advantages set forth above. While embodiments of the present invention have been illustrated and described, it is not intended that these embodiments illustrate and describe all possible forms of the present invention. Rather, the words used in the specification are words of description rather than limitation, and it is understood that various changes may be made without departing from the spirit and scope of the present invention.

1. A video-on-demand system comprising:
a cable provider having videos which are available for delivery from the cable provider to a user of the cable provider;
a set-top-box (STB) associated with the user;
a television associated with the STB; and
a cable television network connecting the STB and the cable provider;
the cable provider having an Internet web site listing titles and descriptive information of the videos, wherein the user uses a computer connected to the Internet to access the web site in order to provide user identification (ID) information to the cable provider and to select a video;
wherein the cable provider uses the user ID information and information indicative of the selected video to deliver the title of the selected video to the STB via the cable television network, wherein the STB displays the titles of videos previously selected by the user from the web site on the television in response to the user directing the STB to display the titles of the previously selected videos on the television;
wherein the cable provider delivers a previously selected video to the STB via the cable television network for the STB to show on the television in response to the user choosing the title of the previously selected video.

2. The system of claim 1 wherein:
the cable provider has a plurality of video servers which store the videos with the cable television network connecting a given one of the video servers to the STB, the cable provider identifying the given video server based on the user ID information;
wherein the given video server uses the user ID information and the information indicative of the selected video to deliver the title of the selected video to the STB via the cable television network;
wherein the given video server delivers the previously selected video to the STB via the cable television network for the STB to show on the television in response to the user choosing the title of the previously selected video.

3. The system of claim 2 wherein:
the cable provider has a Server Locator Service (SLS) for identifying the given video server based on the user ID information.

4. The system of claim 2 wherein:
the user ID information is indicative of IDs of STBs which are associated with televisions of the user, wherein the given video server uses the STB IDs and the information indicative of the selected video in order to deliver the title of the selected video to the STBs via the cable television network;
wherein the given video server delivers the previously selected video to at least one of the STBs via the cable television network for the at least one of the STBs to show on the associated television in response to the user choosing the title of the previously selected video.

5. The system of claim 3 wherein:
the cable provider has an asset management system (AMS) which provides video listing data indicative of the available videos to the web site for the web site to use in order to list the titles of the available videos.

6. The system of claim 1 wherein:
the web site determines a service area of the user from the user ID information, wherein the web site lists the titles of the available videos as a function of the service area of the user.

7. The system of claim 1 wherein:
the cable provider delivers the previously selected video to a video recorder associated with the STB via the cable television network in response to the user choosing the title of the previously selected video.

8. The system of claim 1 wherein:
the user performs a key word search on the web site using the computer in order to select the title of the selected video.

9. The system of claim 1 wherein:
the user uses the computer to browse categories listed in the web site in order to select the title of the selected video.

10. A video-on-demand method for use with a set-top-box (STB) associated with a television of a user, the STB being connected to a cable provider by a cable television network, the method comprising:
storing videos at the cable provider, the videos being available for delivery from the cable provider to the user;
listing titles of the available videos on an Internet web site associated with the cable provider;
using a computer connected to the Internet for the user to access the web site in order for the user to provide user identification (ID) information to the cable provider and to select a video;
communicating the user ID information and information indicative of the selected video from the web site to the cable provider;
using the user ID information and the information indicative of the selected video to deliver the title of the selected video to the STB from the cable provider via the cable television network;
causing the STB to display the titles of videos previously selected by the user from the web site on the television in response to the user directing the STB to display the titles of the previously selected videos on the television; and
delivering a previously selected video from the cable provider to the STB via the cable television network for the STB to show on the television in response to the user choosing the title of the previously selected video.

11. The method of claim 10 wherein the cable provider has a plurality of video servers which store the videos with the cable television network connecting a given one of the video servers to the STB, wherein:
the step of delivering the title of the selected video to the STB includes the given video server using the user ID information and the information indicative of the selected video to deliver the title of the selected video to the STB via the cable television network;
the step of delivering a previously selected video to the STB includes the given video server delivering the previously selected video to the STB via the cable television network for the STB to show on the television in response to the user choosing the title of the previously selected video.

12. The method of claim 11 wherein the cable provider has a Server Locator Service (SLS) which receives the user ID information from the web site, wherein the method further comprises:
using the SLS to determine the given video server based on the user ID information.

13. The method of claim 11 wherein the user ID information is indicative of IDs of STBs which are associated with televisions of the user, wherein:
the step of delivering the title of the selected video to the STB includes the given video server using the STB IDs and the information indicative of the selected video in order to deliver the title of the selected video to the STBs via the cable television network;
the step of delivering a previously selected video to the STB includes the given video server delivering the previously selected video to at least one of the STBs via the cable television network for the at least one of the STBs to show on the associated television in response to the user choosing the title of the previously selected video.

14. The method of claim 12 wherein the cable provider has an asset management system (AMS), wherein:
the step of listing the titles of the available videos on the web site includes the AMS providing video listing data indicative of the videos to the web site for the web site to use in order to list the titles of the videos.

15. The method of claim 10 further comprising:
determining a service area of the user based on the user ID information;
wherein the step of listing the titles of the available videos on the web site includes listing the titles of the available videos on the web site as a function of the service area of the user.

16. The method of claim 10 wherein:
the step of delivering the previously selected video from the cable provider to the STB includes delivering the previously selected video from the cable provider to a video recorder associated with the STB via the cable television network in response to the user choosing the title of the previously selected video.

17. The method of claim 10 wherein:
the step of accessing the web site includes the user using the computer to perform a key word search on the web site in order to select the title of the selected video.

18. The method of claim 10 wherein:
the step of accessing the web site includes the user using the computer to browse categories listed in the web site in order to select the title of the selected video.

19. A video-on-demand system comprising:
a cable provider having videos which are available for delivery from the cable provider to users of the cable provider;
set-top-boxes (STBs) associated with the users;
televisions associated with the STBs; and
a cable television network connecting the STBs to the cable provider;
the cable provider having an Internet web site listing titles and descriptive information of the videos, wherein the users use computers connected to the Internet for accessing the web site in order to provide user identification (ID) information to the cable provider and to select videos;
wherein the cable provider uses the user ID information and information indicative of the selected videos to deliver the titles of the selected videos to the STBs via the cable television network, wherein the STBs direct the televisions to display the titles of the selected videos for the users to view;
wherein the cable provider delivers previously selected videos to the STBs via the cable television network for the STBs to show on the televisions in response to the users choosing the titles of the previously selected videos.

20. The system of claim 19 wherein:
the cable provider has a plurality of video servers which store the videos with the cable television network connecting given ones of the video servers to the STBs, the cable provider identifying the given video servers based on the user ID information;
wherein the given video servers use the user ID information and the information indicative of the selected videos to deliver the titles of the selected videos to the STBs via the cable television network;
wherein the given video servers deliver the previously selected videos to the STBs via the cable television network for the STBs to show on the televisions in response to the users choosing the titles of the previously selected videos.

21. The system of claim 20 wherein:
the cable provider has a Server Locator Service (SLS) for identifying the given video servers based on the user ID information.

22. The system of claim 19 wherein:
the user ID information is indicative of IDs of STBs which are associated with televisions of the users, wherein the given video servers use the STB IDs and the information indicative of the selected videos in order to deliver the titles of the selected videos to the STBs via the cable television network;
wherein the given video servers deliver the previously selected videos to the STBs via the cable television network for the STBs to show on the associated televisions in response to the users choosing the titles of the previously selected videos.

23. The system of claim 20 wherein:
the cable provider has an asset management system (AMS) which provides video listing data indicative of the available videos to the web site for the web site to use in order to list the titles of the available videos.

24. The system of claim 19 wherein:
the web site determines a service area of the users from the user ID information, wherein the web site lists the titles of the available videos as a function of the service areas of the users.

25. The system of claim 19 wherein:
the cable provider delivers the previously selected videos to video recorders associated with the STBs via the cable television network in response to the users choosing the titles of the previously selected videos.

26. The system of claim 19 wherein:
the users perform key word searches on the web site using the computers in order to select the titles of the selected videos.

27. The system of claim 19 wherein:
the users use the computers to browse categories listed in the web site in order to select the titles of the selected videos.
